(19) United States
(12) Patent Application Publication
(10) Pub. No.: US 2006/0146373 A1
(43) Pub. Date: Jul. 6, 2006

(54) Scanning a document to a local portable storage device

(76) Inventor: Brad Corrion, Chandler, AZ (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/027,235

(22) Filed: Dec. 30, 2004

(51) Int. Cl. H04N 1/04

(52) U.S. Cl. 358/474

(57) ABSTRACT

In some embodiments a document is scanned and an electronic version of the scanned document is sent to a local portable storage device. Other embodiments are described and claimed.

### TECHNICAL FIELD

The inventions generally relate to scanning a document to a local portable storage device.

### BACKGROUND

A typical workgroup multi-function printer (MFP) offers multiple services to its users, including copy, fax, and scan-to-email features. Current implementations of obtaining an electronic version of a document scanned on a multi-function printer focus on network export of the document via email. These implementations require the involved procedure of entering in email addresses and passwords. This type of painstaking interaction has limited (and in many cases prevented) the use of such a feature. Therefore, an easier way to obtain an electronic version of a document scanned on a scanning device such as a typical workgroup multi-function printer is desired.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates scanning a document to a storage device according to some embodiments of the inventions.

### DETAILED DESCRIPTION

Some embodiments of the inventions relate to scanning a document to a local portable storage device.

In some embodiments a document is scanned and an electronic version of the scanned document is sent to a local portable storage device.

In some embodiments an article includes a computer readable medium having instructions thereon which when executed cause a computer to scan a document and send an electronic version of the scanned document to a local portable storage device.

In some embodiments an apparatus includes a scanning device having a connector to couple the scanning device to a local portable storage device. The scanning device is to send an electronic version of a scanned document to the local portable storage device.

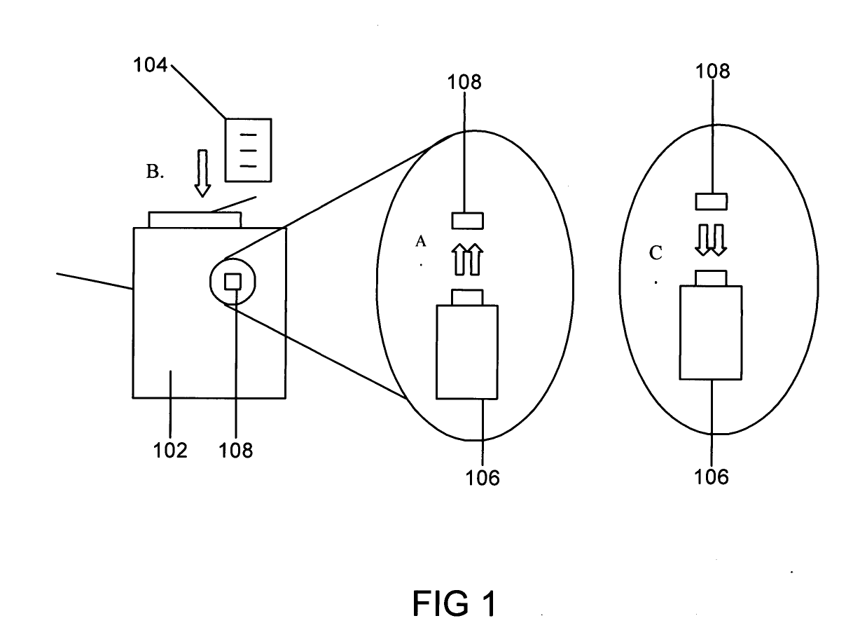

FIG. 1 illustrates scanning a document to a storage device according to some embodiments. A scanning device 102 is used to scan a document 104. In some embodiments scanning device 102 is any print imaging device (for example, a copier, a printer, a multi-function printer, a workgroup multi-function printer, etc.)

In some embodiments storage device 106 is first inserted (depicted at A.) into a connector 108 of the scanning device 102 prior to scanning. In some embodiments the connector 108 of the scanning device 102 can be any connector that accommodates a storage device (for example, a memory device connector, a portable hard disk drive (HDD) connector such as a USB HDD connector, a USB connector, a PCMCIA connector, a compact flash connector, a memory stick connector, a secure digital card connector, a wireless connector that connects electronically with the storage device but not necessarily physically directly connected such as via Bluetooth or WiFi, etc.) In some embodiments the storage device 106 can be any type of portable storage device (for example, a portable hard drive HDD or a portable memory device). In some embodiments the storage device 106 can be any type of portable memory device (for example, a USB key, a USB flash memory key, a flash memory card, a compact flash card, a memory stick card, a PCMCIA card, etc.)

In some embodiments after the storage device 106 is inserted (depicted at A.) into connector 108 of the scanning device then the document 104 is scanned by the scanning device 102 (depicted at B.) After the document 104 has been scanned the scanned electronic version of the document is stored on storage device 106. Once the document has been stored on storage device 106 the storage device 106 may be removed from the connector 108 of the scanning device 102. In this manner a user then has an electronic version of the document on storage device 106 which in some embodiments is a portable device that may be later inserted in other devices (for example, a computer) for later use, storage, viewing, email, etc.

In some embodiments a user is able to scan a document (or documents) and have an electronic version (or representation) of the document (or documents) placed on a portable local storage device (for example, a portable hard disk drive or a portable memory device such as a flash memory card or a USB flash memory key). The user can approach a scanning device (such as a multi-function printer), insert a storage device into the scanning device, select an appropriate scan mode (and/or output version of the document such as a PDF version of the document), and the document is saved to the storage device for later use, retrieval, etc. The user can then remove the storage device from the scanning device and leave with the storage device with the electronic version of the document thereon.

In some embodiments a scanning device (for example, a multi-function printer, a copier, a reprographics machine, etc.) saves an electronic version of scanned documents to a local storage device such as a local memory device (for example, a local flash memory device).

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state, or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A method comprising:
scanning a document; and
sending an electronic version of the scanned document to a local portable storage device.

2. The method of claim 1, wherein the local portable storage device is a portable hard disk drive.

3. The method of claim 1, wherein the local portable storage device is a local portable memory device.

4. The method of claim 3, wherein the local portable memory device is at least one of a flash memory card or a USB flash memory key.

5. The method of claim 3, wherein the local portable memory device is a flash memory device.

6. The method of claim 1, further comprising receiving at a connector the local portable storage device prior to the scanning.

7. The method of claim 1, further comprising coupling to the local portable storage device prior to the scanning.

8. The method of claim 7, further comprising uncoupling from the local portable storage device after the scanning.

9. An article comprising:
a computer readable medium having instructions thereon which when executed cause a computer to:
scan a document; and
send an electronic version of the scanned document to a local portable storage device.

10. The article of claim 9, wherein the local portable storage device is a portable hard disk drive.

11. The article of claim 9, wherein the local portable storage device is a local portable memory device.

12. The article of claim 11, wherein the local portable memory device is a flash memory device.

13. A apparatus comprising:
a scanning device including a connector to couple the scanning device to a local portable storage device, the scanning device to send an electronic version of a scanned document to the local portable storage device.

14. The apparatus of claim 13, wherein the apparatus is a multi-function printer.

15. The apparatus of claim 13, wherein the local portable storage device is a portable hard disk drive.

16. The apparatus of claim 13, wherein the local portable storage device is a local portable memory device.

17. The apparatus of claim 16, wherein the local portable memory device is a flash memory device.

18. The apparatus of claim 17, wherein the flash memory device is at least one of a flash memory card or a USB flash memory key.

19. The apparatus of claim 13, further comprising a connector to couple the scanning device to the portable storage device.

20. The apparatus of claim 19, wherein the connector is a slot in the apparatus in which the portable storage device may be inserted.

21. The apparatus of claim 19, wherein the connector is a USB connector.

22. The apparatus of claim 19, wherein the connector is a flash memory card connector.

23. The apparatus of claim 19, wherein the connector is a wireless connector.
